(19) United States
(12) Patent Application Publication
(10) Pub. No.: US 2016/0267518 A1
(43) Pub. Date: Sep. 15, 2016

(54) METHOD FOR MOTIVATING AN INDIVIDUAL TO VIEW PROMOTIONAL CONTENT

(71) Applicants: GEORGE GLOVER, BROOKSVILLE, FL (US); BRUCE D. MILLER, NORTH READING, MA (US)

(72) Inventors: GEORGE GLOVER, BROOKSVILLE, FL (US); BRUCE D. MILLER, NORTH READING, MA (US)

(21) Appl. No.: 14/643,349

(22) Filed: Mar. 10, 2015

(51) Int. Cl. G06Q 30/02; H04N 21/81

(52) U.S. Cl. CPC G06Q 30/0236; H04N 21/812

(57) ABSTRACT

An interactive computer application operates to displays promotional content to a registered user. The interactive computer application directs the user to watch promotional content and to select and answer questions relating to the promotional content. The user is permitted to receive a reward if they select and answer a number of questions correctly that is equal to or greater than a threshold number of correctly answered questions.

### 1. FIELD OF THE INVENTION

The present disclosure relates to the use of a reward system to incent an audience to watch promotional content relating to a media content, commercial product or service.

### 2. BACKGROUND

Textual, audio, audio/video or multi-media information (together termed as media information) can be distributed for consumption by individuals comprising an audience in a number of different formats. This media information can be distributed physically or electronically in a text format, it can be distributed in an audio or audio/video format, or it can be distributed in a multi-media format. This media information can be distributed as TV program content, Internet program content, radio program content or promotional or product advertising content directed to a program, product or service. Distributors of program content (content distributors) typically urge an audience to view program content by broadcasting program promotions, and these distributors generally sell program and product promotional time as a means to offset the cost of creating and distributing program content and to compensate the individuals who manage the entities that create and distribute the content. The program and product promotions or advertisements are generally played during breaks in regular program content (commercial or promotional breaks) or more generally during times that regular program content is not available to be viewed by the audience, but these promotions can be played coincident with the regular program content. This promotional time can be more or less costly to purchase depending upon the program content type (type of TV programming . . . sports, movie, weekly program, etc.) being played proximate to the time that promotional content is played, it can be more of less costly depending upon the time during the day, week or year that the program content is played or available for viewing, or it can be more or less costly depending upon the targeted demographic group of the audience and the number of anticipated viewers of the program content. In this regard, the distributors of program content make every effort to maximize their promotional revenue by tailoring program content to a particular demographic group, and broadcasting or playing the program at a time during which it will be viewed by the largest possible audience.

### 3. BRIEF DESCRIPTION OF THE DRAWINGS

The present invention can be best understood by reading the specification with reference to the following figures, in which:

FIG. 1A shows a device 10 displaying promotional content associated with a commercial product.

FIG. 1B shows the device 10 displaying promotional content associated with a TV program.

FIG. 2 shows a mobile communication device 20 running an interactive viewer application ABC displaying a promo listing screen.

FIG. 3 shows the mobile communication device 20 running the interactive viewer application ABC displaying information associated with a promo 1.

FIG. 4 shows the mobile communication device 20 running the interactive viewer application ABC displaying a listing of clues associated with the promo 1.

FIG. 5 shows the mobile communication device 20 running the interactive viewer application ABC displaying Q&A information associated with clue 1.

FIG. 6 shows the mobile communication device 20 displaying a list of user selectable activities.

FIG. 7 shows the mobile communication device 20 displaying content associated with a user activity A.

FIG. 8A is a diagram showing functional elements comprising the interactive viewer application ABC.

FIGS. 8B-8E are diagrams showing information and questions associated with each instance of a promotion stored in association with the interactive viewer application ABC.

FIG. 9 is a diagram showing functional elements comprising the user activity A.

FIG. 10 is a high level diagram showing the functional elements comprising the interactive viewer application ABC.

FIG. 11A is a logical flow diagram of the control logic 81 comprising the interactive viewer application ABC.

FIG. 11B is a continuation of the logical flow diagram of FIG. 11A.

FIG. 12 is a flow diagram of the logic associated with option button functionality comprising the interactive viewer application ABC.

### 4. DETAILED DESCRIPTION

Methods used to bring program content (TV, Radio, etc.) or commercial products (drinks, sporting gear, cars, etc.) to the attention of individuals in an audience can vary depending upon the means employed to distribute the programming content or commercial products. But regardless of the means used to distribute the various types of content, the method used to attract an audience to view a program or to purchase a product is generally referred to as a promotion or abbreviated as promo. Promotional content can be played by a television or radio during a time that program content is not available to be viewed by an audience (promotional break) or coincident with the program content. This strategy for the delivery of promotional content provides individual viewers in an audience with the opportunity to tune out the promotions during the course of a program, or if the viewer is recording the program content, they can easily skip the promotional content when playing the recorded program. This sort of audience behavior can frustrate content distributors' attempts to reach a maximum number of viewers in an audience.

In order to overcome the problems associated with individuals in an audience ignoring program or product promotion content, hereinafter referred to as simply promotional content or a promotion, in order to provide those organizations responsible for creating and/or distributing program content (content distributor) with increased promotional revenue, and in order to attract viewers to watch program content, we have invented a methodology that motivates or incents individuals in a viewing audience to watch this promotional content by rewarding them for participating in an activity that is associated with the promotion content. The activity can be implemented in an interactive computer or viewer application running on any type of computational device that is configured to connect to a network (private or public). The interactive computer application can present individuals using the application (users) with a listing of one or more instances of promotional content that are available for viewing, and it can present the users with instructions that allow them to find and view the promotional content. Users can select one or more of the listed instances of promotional content for viewing, and depending upon which instance of promotional content is selected for viewing, they can be presented with questions or clues that are created for that instance of promotional content. The user can respond to each question or clue presented to them, and the interactive computer application (viewer application) is configured to receive each response. The application can operate to determine how many of the responses received from a user are correct or acceptable, and depending upon each user's success rate in answering the questions or responding to the clues, they can receive a reward that is commensurate with their success rate. In this manner, content distributors can incent an audience to view promotional content associated with programs and commercial products with the hope that this same audience will be motivated to view the associated programs or purchase the associated products.

The reward received by a user can be permission to participate in an activity that leads to an opportunity to win money or to win a prize, to play a game or to enter into some other activity made available for selection by the viewer. The user may be required to watch promotional content associated with a program or commercial product prior to being permitted to participate in the activity or the user may be required to watch promotional content during the course of participating in the activity, or in order to continue participating in the activity. These and other aspects of the invention are described below with reference to the Figures.

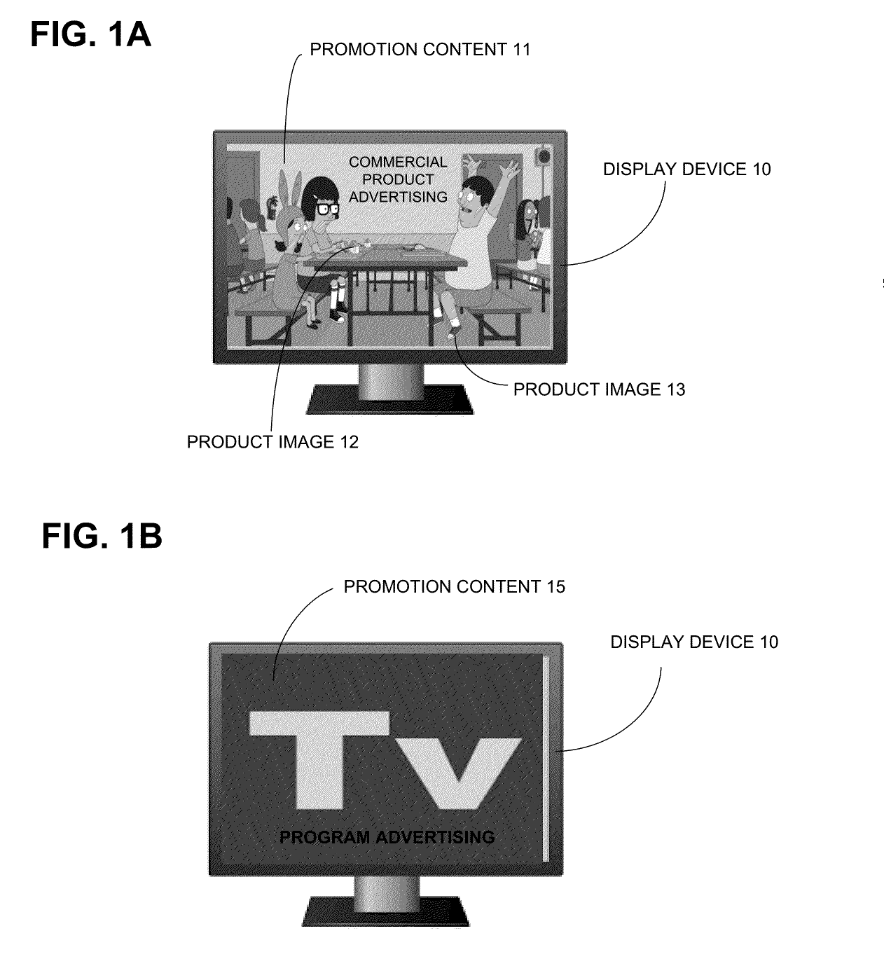

FIG. 1A shows a media display device 10 displaying promotional content 11, which in this case is a multi-media advertisement for two commercial products 12 and 13. The display device 10 can be a television, a computer screen or any stationary or portable electronic device capable of receiving media information (text, audio, video, audio/video or multi-media information) over a public or private network and displaying it as media content. Promotional content 11 can be any live or pre-recorded information broadcast or distributed by a content distributor, such as a television network or an Internet content distributor, over an appropriate communication network to the display device 10 (could be a radio as well). The promotional content 11 in this embodiment is related to a commercial product, but, as shown in another embodiment with reference to FIG. 1B, promotional content 15 can also be related to a TV program promotion or a movie promo transmitted over the air or over a cable network (Internet o content or cable network content). After the media information is received by the display device 10 in FIG. 1A, the information can either be played immediately as promotional content, or stored for later viewing.

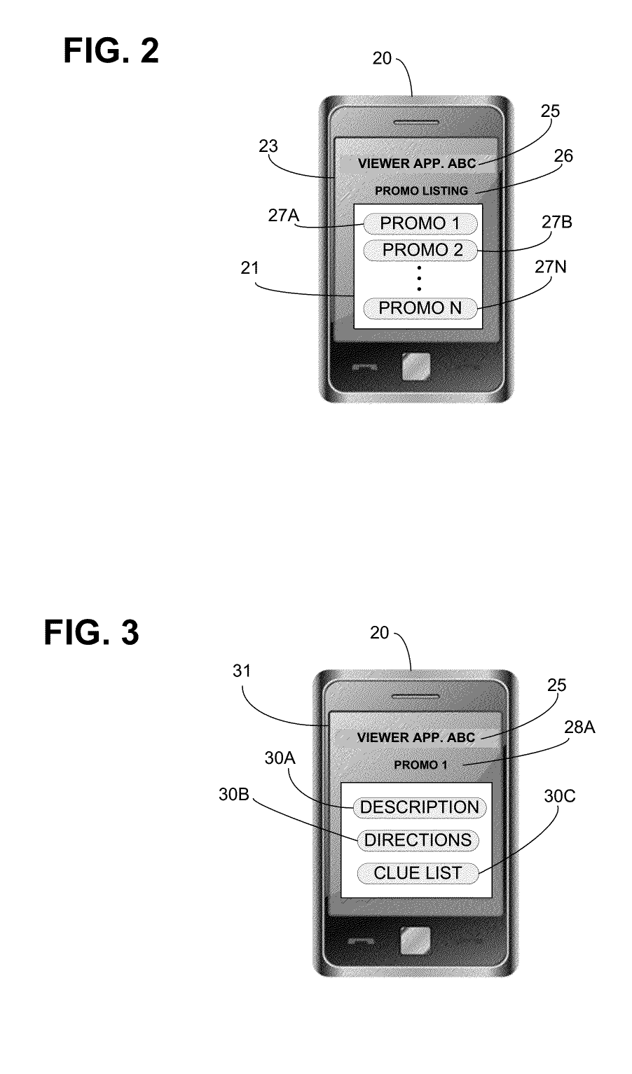

FIG. 2, shows the portable communication device 20 with a display 23 showing a first application screen (first screen) of information associated with an interactive computer application ABC. Hereinafter, the application ABC is interchangeable referred to as a viewer application ABC or a computer application ABC, but it should be understood that these terms refer to the same application ABC running on a mobile communication device or on a computational device. The first screen displayed in FIG. 2 has a number of different fields, and each field can display a different type of information for viewing and to be interaction with by a user. A field labeled 25 includes the name of the interactive viewer application, which in this case is application ABC, a field 26 is labeled “promo listing” which is an indication of the type of subject matter comprising the screen, and a field 21 has a listing of promotional content instances labeled PROMO 1, PROMO 2 to PROMO N (N being an integer). Each instance of promotional content represents a pointer to additional information associated with that instance of promotional content and is available for selection by the device 20 user. When an instance of promotional content is selected, another, second screen is displayed that provides the device 20 user with information they can use to find and to watch the instance of promotional content. This second screen is illustrated and described with reference to FIG. 3 below. The interactive viewer application can comprise a thin client running on the communication device 20 and a full client or thick client application running on one or more remote servers as an Internet Cloud based application, or the interactive viewer application can be a full application running on the communication device 20.

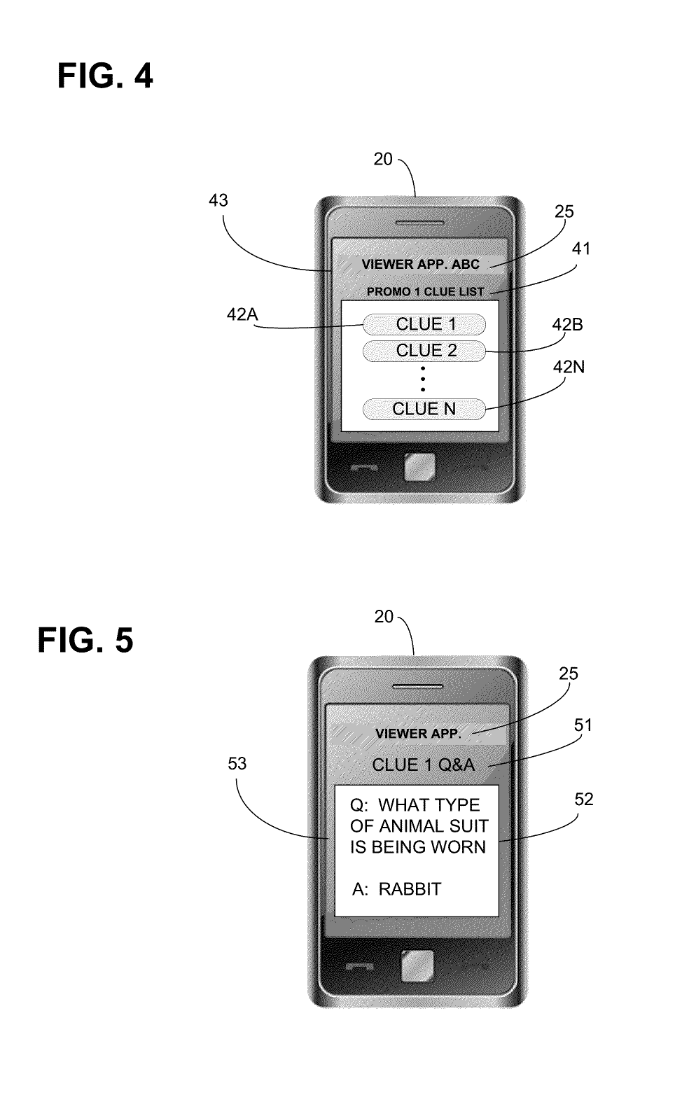

FIG. 3 shows the communication device 20 displaying the second screen 31 comprising a number of different fields of information. A field 28A references back to the field 27A in the first screen, a field 30A comprises a description of the content in PROMO 1. This description can include a brief synopsis of the subject matter of the content, such as whether the content is a product promotion or a program promotion, and the subject matter associated with the promotion, such as the type of product and the format of the promotion. A field 30B comprises directions that the application 25 user can employ to locate and watch the content associated with the PROMO 1. These directions can include such information as the date and time that the promotional content is being played and it can include a TV channel on which the content is being played or an Internet address to can be used to find and view the content. A field 30C comprises a pointer to a listing of questions or clues that are displayed by the application ABC for the user to respond to. By selecting the field 30C, the application operates to display a third screen that is shown and described with reference to FIG. 4.

Among other things, FIG. 4 illustrates the third application screen having a listing of references or pointers (labeled CLUE 1, CLUE 2, to CLUE N, with N being an integer) to clues and/or questions relating to the instance of promotional content selected by the application ABC user, which in this case relates to the instance of promotional content identified as PROMO 1 in FIG. 2. Each pointer can be included in a separate field in the third screen 43 and can be selected separately from each one of the other pointers displayed in the screen. When a pointer is selected, CLUE 1 for instance, the application ABC can operate to display another, forth screen 53 that displays a text of the clue/question selected by the user, and to display an answer field labeled “A”. This forth screen is illustrated with reference to FIG. 5. While the user is viewing an instance of selected promotional content, they can select, view and respond to one or more of the questions associated with that promotional content. The intent of the questions included in this third screen is to incent or motivate the user to pay close attention to the promotional content while they watch it, and the degree to which the user is able to respond correctly to each question can determine how the user is rewarded, or it can determine the value of the reward. For example, if the third screen shown with reference to FIG. 4 displays ten questions, and the user selects and correctly answers all of the questions correctly, the reward that they could receive can be of some maximum value. Conversely, if the user selects all 10 questions and answers fewer than ten correctly, the reward can be reduced. The reward in this case can be monetary, it can be permission to enter into a user activity, it can be promotional material such as a poster, it can be an item that provides the user with some advantage in an activity they are currently participating in, such as a weapon for a video game, or it can be a discount for some goods or services.

The interactive viewer application ABC can be designed or configured, by the content distributor (TV network or Internet content distributor) or by a third party, to download and store the questions described with reference to FIG. 5 above. The application ABC can receive input from the viewer in several different ways. The input can be text, the input can be speech, or the input can be the result of a product image being selected by a screen cursor operating in conjunction with the display device 10.

The viewer application user can be required by the application ABC to select and correctly answer some specified minimum number of questions associated with a selected instance of promotional content in order to be permitted to participate in a user activity. This minimum number of answers can be configured in the application ABC by the organization responsible for broadcasting the video content (content distributor) or by some other third party organization responsible for the operation of the program application. In an alternative embodiment, an award of greater value can be permitted if the application user correctly answers a number of questions that is greater than this minimum specified correct answers.

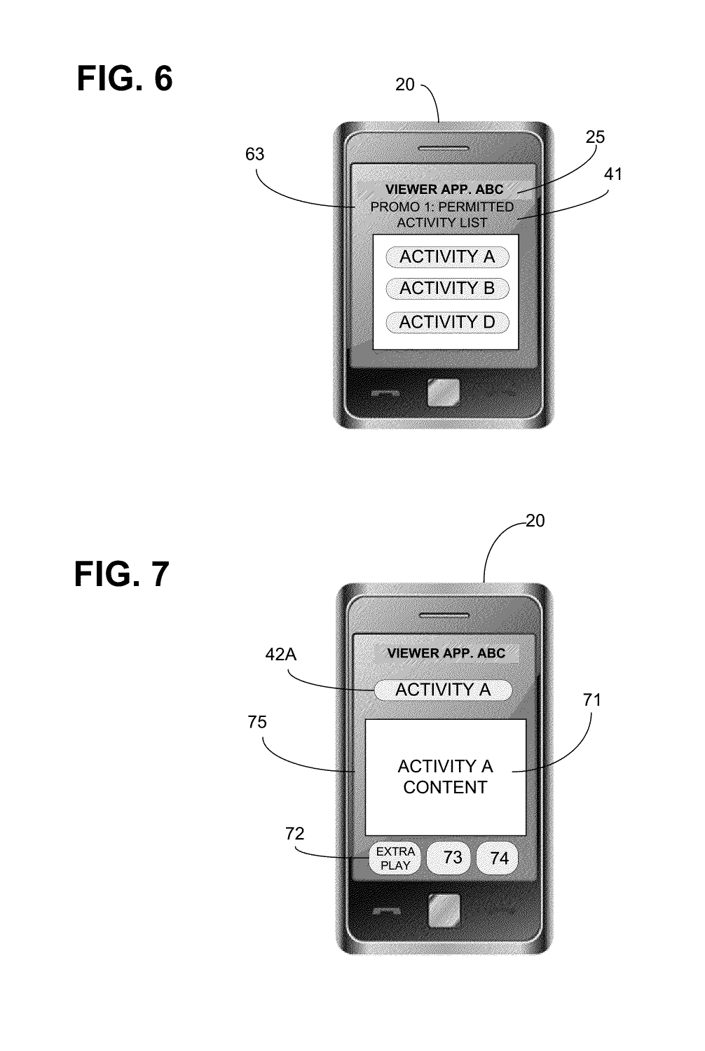

Further to the above, the interactive viewer application ABC operates to determine how many user activities a viewer is permitted to participate in depending upon the number of questions they select and the number of questions they correctly respond to. The number of activities that an application user is permitted to participate in is determined by logical computer instructions running in conjunction with the application ABC. Subsequent to the user watching promotional content and responding to the questions associated with the promotion, the interactive viewer application can display in a fifth screen a listing of the rewards/activities that the user is permitted to receive or participate in. This listing of permitted rewards or activities is illustrated and described with reference to FIG. 6 below.

FIG. 6 illustrates the communication device 20 described earlier running the viewer application ABC which operates to display a fifth screen 63 as the result of the user selecting and correctly responding to at least a minimum number of questions. The fifth application screen in this case displays a plurality of activities that the user is permitted to participate in, which in this case is an Activity A, Activity B and Activity D. While the viewer application ABC operates in this case to display a number of activities or rewards from which the user is permitted to select and participate in. The application ABC can also display a reward that is other than an activity that the user can participate in. Such a reward could be monetary in nature, such as a coupon granting a discount on a product or service, a cash reward, points towards a reward, or the reward can be non-monetary in nature such a permission to watch a subscription program on TV for instance. Regardless of the type of reward or activity displayed in the fifth screen, the application user can select an activity, Activity A for instance, and the Application ABC can operate to display Activity A content 71 in a sixth screen as illustrated and described below with reference to FIG. 7.

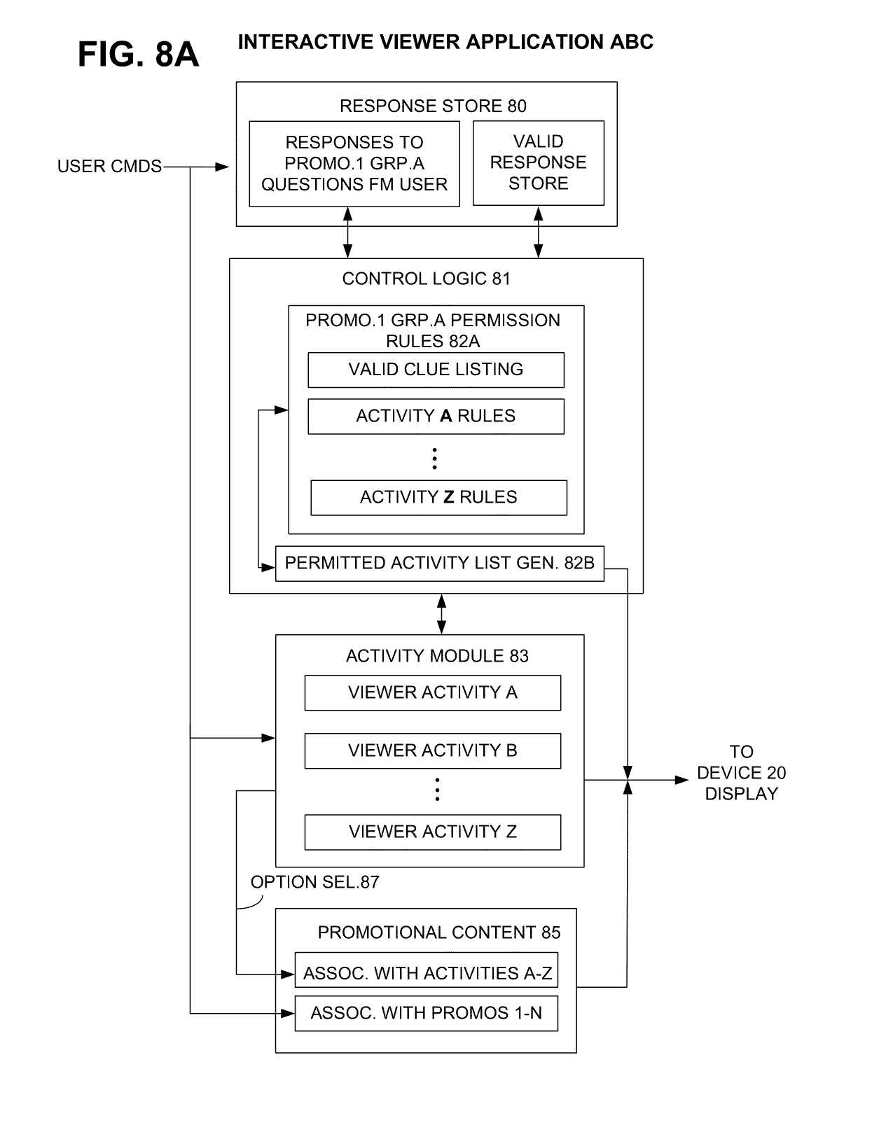

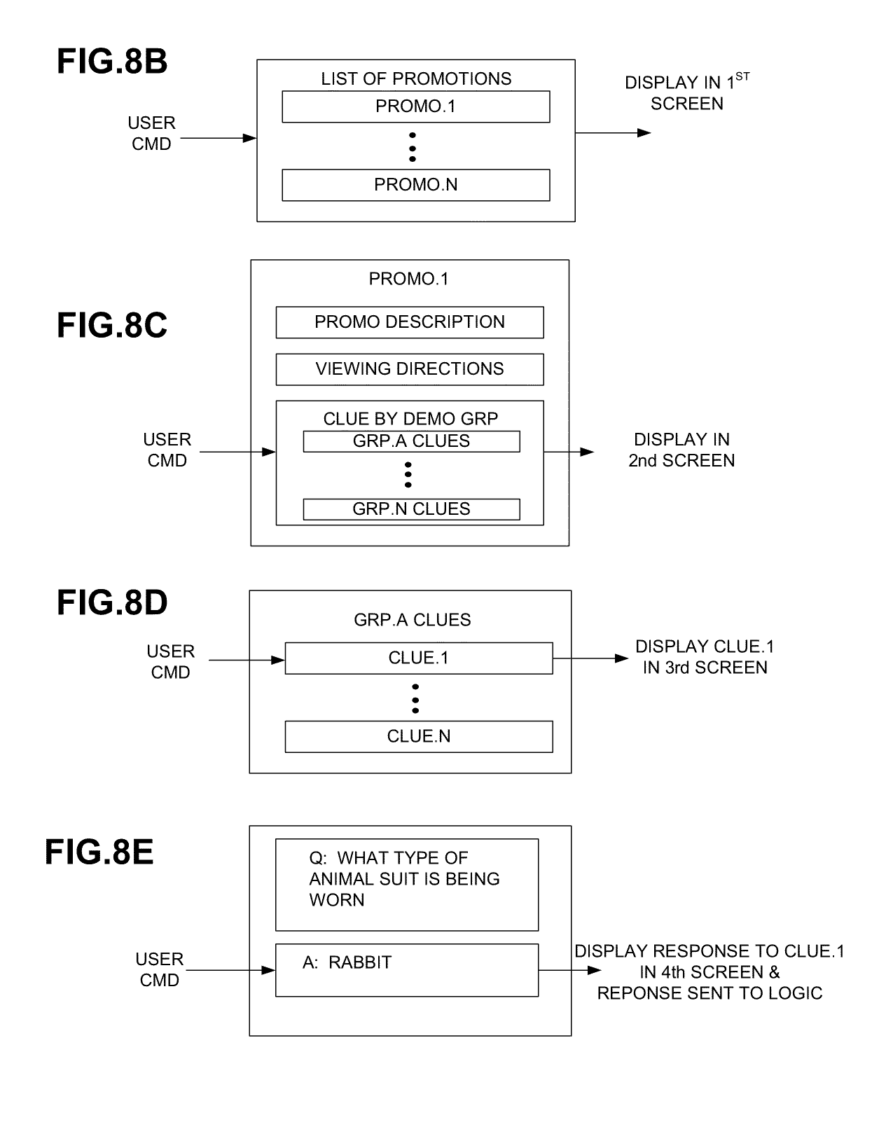

The content displayed in the sixth application screen 75 shown in FIG. 7 can be content comprising only text, video, or audio content or comprising any combination of text, audio and video content (multi-media content). Regardless of the type of content displayed in the sixth screen, the Application ABC can operate to allow the viewer to interact with the content in order to play a game (if the content relates to a game), to interact with the content in a manner that affects the progress of the Activity A in some manner (the game continues for instance), or the viewer's interaction with the content can lead to a reward. Also shown in the sixth screen are three fields that can be selected by the user to control the Activity A in some manner. These fields are activity control buttons (option buttons) labeled 72, 73 and 74. Each of these buttons can be selected by a viewer permitted to participate in the activity to control some aspect of the activity (Activity A) and to display promotional content to the viewer. If the viewer selects the option button labeled 73, a promotion control signal is sent to promotion control logic (described later with reference to FIG. 8) that controls the Application ABC to operate to display in another application screen information or promotional content relating to a program or product that is the subject of the PROMO 1 in this case. This content can be text, audio, video or multi-media content, and the user may or may not be able to interact with this content. According to this embodiment, selection of the button 72 can allow the user to continue participating in the activity at the end of a session (end of the session in this context means that the game is over) and after some promotional content is played by the Application ABC. The functional elements comprising the viewer application ABC are described below with reference to FIG. 8.

FIG. 8 is a block diagram showing functional elements comprising an embodiment of the application ABC running on a communication device such as the device 20 described earlier with reference to FIG. 1. The application ABC has a response store 80, a control logic module 81, an activity module 83, and a store of promotional content 85. The store of promotional content 85 is comprised of promotional content associated with the activities A-Z (activity promos) described earlier with reference to FIG. 7, and it is comprised of information and content associated with each instance of the promotion 1-N described earlier with reference to FIG. 2. The information associated with each instance of a promotion 1-N and the operation of the viewer application ABC with respect to each instance of a promotion 1-N is described later in detail with reference to FIG. 8B. However, when initiated the application ABC can display one or more of the promotions 1-N for selection by the application user. Once selected, the application can then display information associated with each instance of a promotion for viewing and/or selection by the application user, and the application can display clues or questions associated with each promotion that the user can respond to.

The store 80 in FIG. 8A maintains information comprising responses to questions entered by a user (which in this case corresponds to responses associated with promo.1 and demo group A) of the application ABC, and it maintains information comprising responses to questions answered by the user that the logic 81 determines are valid. The information associated with valid responses can be maintained by the application ABC for as long as it takes the logic 81 to determine if the user is permitted to receive a reward, such as being permitted to participate in an activity, and how many and which activity the viewer is permitted to participate in, but this information can be maintained longer.

The control logic 81 referenced in FIG. 8 comprises permission rules 82A and a permitted activity list generation module 82B. The permission rules 82A in this case are associated with particular promotional content, PROMO.1, and they are associated with a particular demographic group, GRP.A, and each instance of promotional content can have different rules 82A that are tailored for a particular demographic group, or not. The logic 81 operates on the valid user response information maintained in the store 80, and on information comprising the permission rules 82A to, as described earlier, determine whether a response by the user to a questioned displayed by the application ABC is correct/valid or not, and that the number of correct responses entered by the user is equivalent to at least a threshold number (configured in the permission rules 82A). As described earlier, this threshold number of correct responses can be configured by a content distributor to be any value depending upon, for example, the length of time that the promotional content is played, the number of different types of images that comprise the promotional content, or for any other reason. More specifically, the permission rules 82A comprise a store of correct or valid responses for each question associated with each instance of promotional content, and they comprise a store of reward or activity rules A to Z in this case. Each one of the activity rules can be configured by the content distributor to include a threshold value that the logic 81 compares to the number of valid responses received by the application ABC. Provided the number of valid responses received by the application is at least equivalent to the threshold value, the user is permitted to receive a reward which can include permission to participate in at least one, or possibly more than one activity. The control logic 81 also controls the operation of the module 82B to operate on the results of the permission rules 82A to generate a listing of rewards or activities from which the user is permitted to select in order to receive a reward or to participate in one or more activities. This listing is sent by the control logic to the communication device 20 display where it can be viewed and selected by the user. Depending upon whether a user is given permission to participate in one or more activities, the logic 81 can control the application ABC to display one or more activities on the communication device display, and any one or more of these displayed activities can be selected by the user to participate in.

In the event that a user correctly enters more than the threshold number of correct responses, the logic 81 can operate, in conjunction with the rules 82A, to permit the user to participate in more activities (or receive a reward of higher value) than they would otherwise be permitted to participate in if they only enter a number of correct responses equal to the threshold value. The type of information comprising a user response that is required to be entered into the application ABC can change from one instance of promotional content to another, or from content distributor to content distributor, and the user can be instructed by the application ABC or by content included in a promotion what type of response information is required to be entered. The permission rules 82A are described below in greater detail.

Continuing to refer to FIG. 8, each instance of an activity rule (A-Z) comprising the permission rules 82A corresponds to a particular activity that a viewer can be permitted to participate in (or corresponds to a reward that the user is permitted to receive), and each instance of an activity rule can have a threshold value this is different or the same as any other instance of an activity rule. For example, activity A rules can have instructions that only permit a user to participate in this activity if they correctly respond to a number of questions that is greater than a threshold number, or it can have instructions that permit a viewer to participate in this activity if they correctly response to a number of questions that is equivalent to the threshold number. Each of the other activity rules can have similar or different instructions.

The logic 81 can receive commands from the user as the result of any of the activities, Activity A, Activity B and/or Activity D, displayed on the fifth screen by the application ABC being selected by an application user. After receiving such a command, the logic 81 can initialize the selected activity and the communication device 20 can display content associated with the activity to be viewed and participated in by the application user. Content associated with each activity is stored in an activity module 83, and this activity module has one or more instances of content, each instance of which is associated with a different activity. In this case, the module 83 is storing an activity A to activity Z. Each activity can have textual or multi-media content that the application user can interact with while viewing the content. Option button information (described earlier with reference to FIG. 7) can be associated with each instance of the activity content, and this content can be displayed on the same screen (the sixth screen) as the content for selection by the user. The user can select any of the option buttons 72, 73 or 74 at any time while they are participating in an activity. Selection of an option button causes the activity that the user is participating in to send one or more option instructions to the control logic 81 that are operated on by the logic to determine which one of multiple instances of promotional content, maintained in a store 85, are played on the user device 20. Further, one of the option instructions sent to the control logic 81 can be used by the logic to control the operation of the application ABC to permit the user to continue participating in the current activity (another play), to participate in a different activity, or to participate in an additional activity that they were not previously permitted to participate in, or to control the application ABC in some other manner.

Turning now to FIG. 8B, as described earlier, the promotional content store 85 maintains information and content associated with each instance of a promotion, labeled PROMO.1-PROMO.N. After the application is initialized by an application user, the application ABC can operate to display a listing of each instance of the promotion 1-N on the mobile communication device 20 for viewing and selection by the application user. If the user selects PROMO.1, the application operates to display information and one or more groups of questions or clues associated with this promotion. The displayed information can be comprised of a brief description of the content associated with the promotion and directions to be followed that allow the user to view the promotion. Each of the one or more groups of questions or clues associated with each instance of a promotion can be tailored to a particular demographic group, and by selecting one of the groups of clues, the user can view, as illustrated in FIG. 8D, each of the questions comprising that group. FIG. 8E shows the contents of a selected clue and the users response which is sent to the application ABC logic 81.

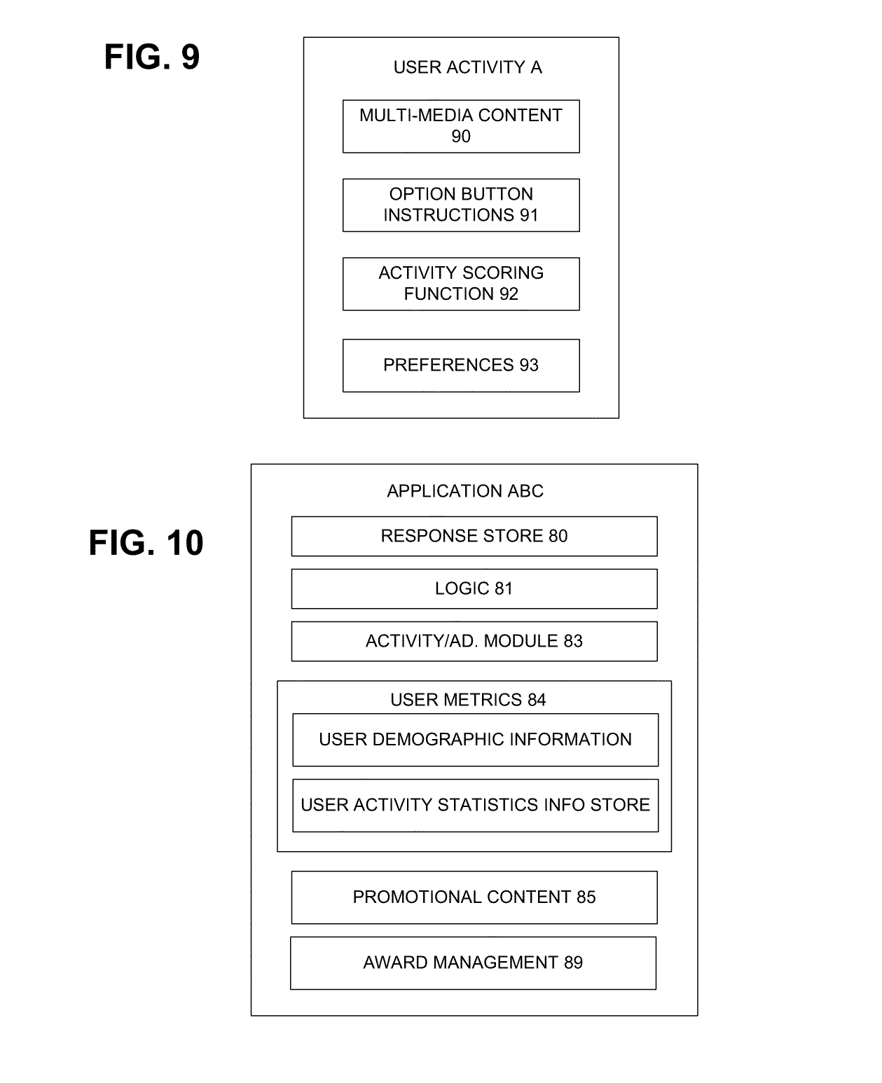

As described earlier with reference to FIG. 8A, each application user activity A-Z comprises activity content and option button instructions, and each one of the user activities can also have an activity scoring function. The elements comprising a user activity are described in more detail as follows in FIG. 9. The user activity A can have multi-media content 90 which can be a video game, it can be a game that does not have any video content, or it can be any type of content that a user can interact with in order for the activity to be completed. Each user activity can have instructions 91 that are associated with each of one or more option buttons, and each option button can be a point to an instruction that, after a button is selected, can be operated on by the logic 81 to control the application ABC to play one or more instances of advertising content 85, or each option button can be a pointer to an instruction that can be operated on by the logic to control the application to permit the user to participate in one or more optional activities. Also shown is an activity scoring function 92 that maintains a store of the users interactions with the activity and a current quantitative accounting of the user's success while participating in the activity. The accounting of the user's success can be maintained as an integer value or in some other form, regardless, the quantitative measure of the user's success can be used by an reward management module, described later with reference to FIG. 10, to determine whether the user earns a reward as the result of their interaction with an activity, whether the activity is completed or not. Also shown, is a preferences function that maintains a current listing of the types of activities an application user participates in most. In the event that the application ABC permits the user to participate in a large number of activities, the number of activities that are displayed to the user for selection can be controlled to a reasonable number so that the user can more easily select an activity of interest to them.

FIG. 10 is a high level diagram showing the functional elements comprising the application ABC. As described earlier with reference to FIG. 8, the application ABC has a store of valid responses 80, it has control logic 81, a user activity module 83, and a store of promotional content 85. In addition to the functional elements described with reference to FIG. 8, FIG. 10 shows a store of user metrics information 84 and a reward management module 89. The store of user metric information 84 comprises a user demographic information that can be collected during a registration process, and it comprises a user activity statistics information store that can be collected by the application during the time the user is interacting with it.

As mentioned above, the store of user demographic information is maintained as the result of collecting this information from application users during a registration process. Prior to an individual being allowed to access the first screen of the interactive viewer application ABC, they are prompted to enter certain personal information into the application. The application ABC can prompt the individual for, among other things, their age, home address, nationality, annual income, marital status, number of children, whether or not they have pets and if so what type, and the application can prompt the individual to enter information relating to their TV viewing or Internet usage habits, such as the TV channels they watch, types of movies they watch, or Internet address which they most commonly frequent. Also, as mentioned above, the user activity statistics can be collected by the application ABC during any time that the user is interacting with any of the screens, one to six, comprising the application. Any of the information comprising the user metrics 84 can be available to program content distributors or to a third party system administrator for a number of different purposes. Among other things, these metrics can be used to tailor promotional content and distribution so that they reach the widest possible audience interested in the content, these metrics can be used to tailor the questions or clues presented to a user by the application ABC to an audience comprising a particular demographic mixture, and these metrics can be sold to advertisers for the purpose of informing them about the effectiveness of their promotional content or who is watching the content and when they are watching it.

Finally, the reward management function 89 can use the information maintained by the activity module 83 to award cash or other types of prizes to a user participating in one or more activities. The type and value of the award can be determined by, among other things, promotional revenue associated with any particular user activity, it can be determined by the success with which a user participates in an activity, or it can be determined in some other manner.

Previously, the user is described as entering responses into a communication device 20 that is a separate physical device from the display device 10, but this does not have to be the case. In another embodiment, the display device 10 can be an interactive device (such as an interactive television device) that can run the application ABC. In this case, the application user can use a remote control device to interact with the application ABC. Alternatively, if the display device 10 has a touch screen, the user can interact with the application by simply touching the screen, and the clues are automatically entered into the program application as before.

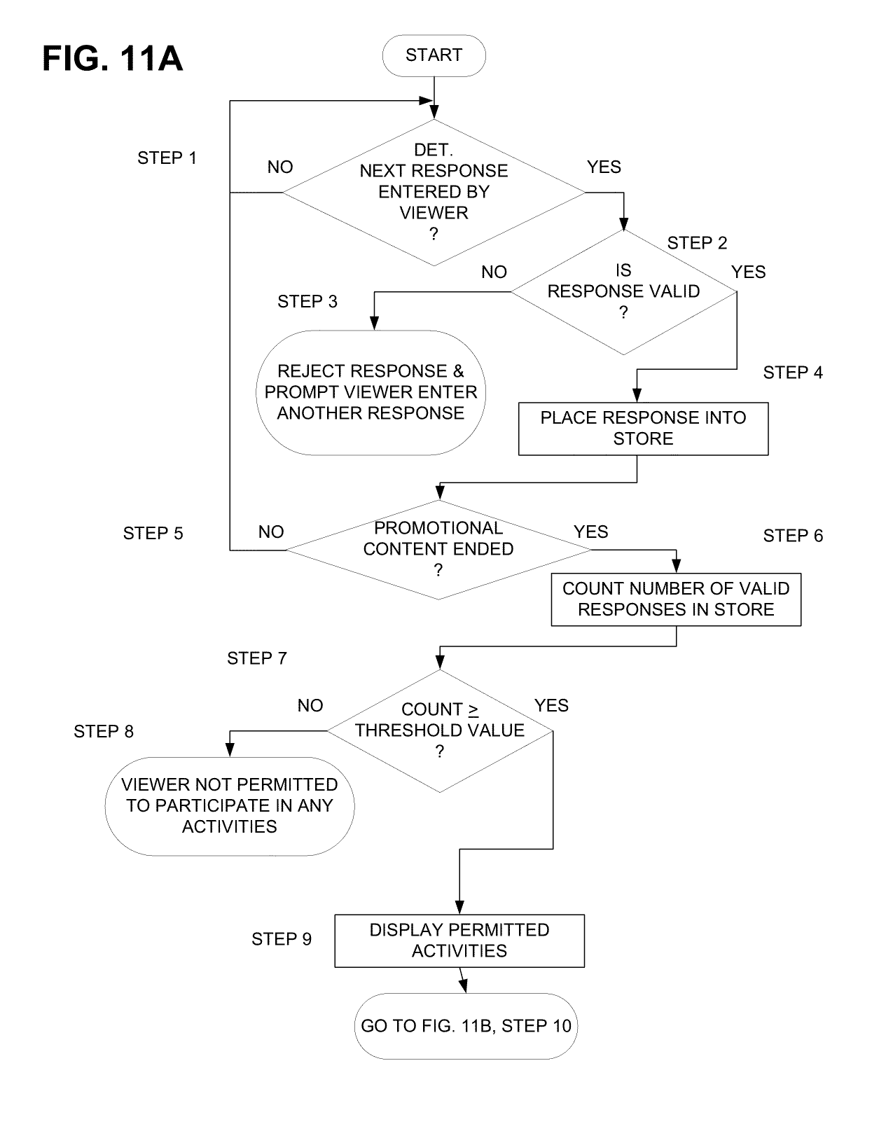

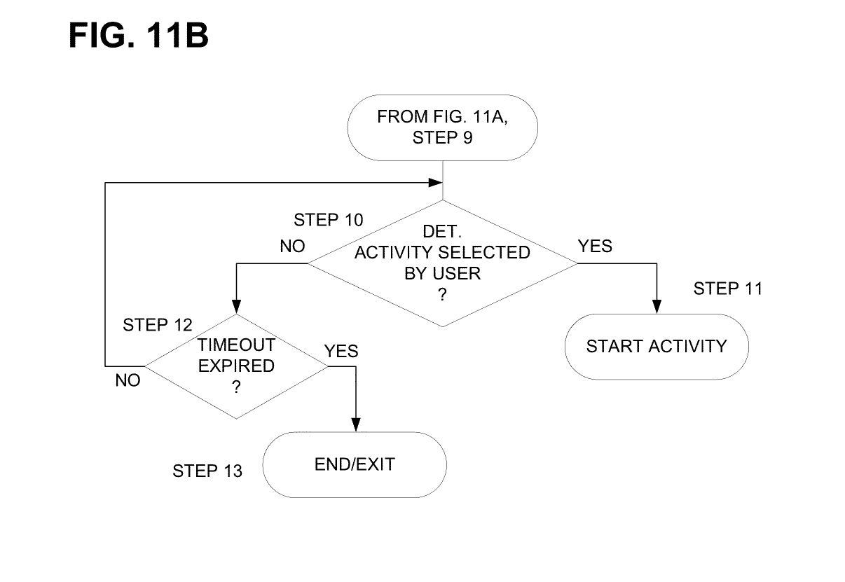

As described earlier with reference to FIG. 8, the control logic 81 operates to determine whether or not a user is permitted to participate in an activity, it operates to control the application ABC to play the content associated with the activity, and it operates to control the optional button functionality. The operation of this logic is now described in more detail with reference to FIGS. 11A and 11B. Referring first to FIG. 11A, if in Step 1 the logic 81 detects a first or next user response the process proceeds to Step 2 where the logic 81 determines whether or not the response is valid. If the logic determines that the response is not valid, it can operate to discard the response. In order to determine whether a response entered by the user is valid, the logic 81 can operate to examine each entry in the valid response store 82 described with reference to FIG. 8, and compare the most recent response entered by the user to each entry in the listing 82 for a match. If the logic detects a match, then the response is determined to be is valid, and in Step 4 the response information is maintained in the store 80, otherwise the logic determines that the response is not valid and in Step 3 the response is discarded and the user can be notified of this and given the opportunity to enter another response.

Continuing to refer to FIG. 11A, in Step 5, if the promotional content has ended, the process proceeds to Step 6 and the logic causes the valid response(s) currently maintained in the store 80 to be counted, and in Step 7 the valid response count is compared to each of the threshold values configured in the activity rules A to Z. If the response count is not equal to any of the threshold values configured in any of the activity rules, then in Step 8 the user is notified that they are not permitted to participate in an activity and the application ABC terminates. Alternatively, the user can be prompted to watch the promotional content again. On the other hand, if in Step 7 the logic determines that the valid response count is equal to or greater than one or more of the threshold values set in the activity rules, then in Step 9 the logic causes each of the one or more activities corresponding to these rules to be displayed in the fifth screen described with reference to FIG. 6.

Referring now to FIG. 11B, in Step 10, the application ABC either detects or does not detect that the application user selects an activity displayed in the fifth screen, and if an activity is selected, the process proceeds to Step 11 and the application ABC starts the selected activity or provides reward information. As previously described, this activity can be content associated with a video game, a quiz, or any other activity that the user can interact with in some manner. On the other hand, if the application ABC does not detect that the user selects an activity, the process proceeds to Step 12 and the application ABC determines whether a timeout threshold is reached. If not, then the process returns to Step 10, otherwise the process proceeds to Step 13 and the application user is either prompted to log out of the application or the application ABC simply terminates.

Referring again to FIG. 11A, and in an alternative embodiment, if in Step 2 it is determined that response information entered and detected in Step 1 is not valid, in Step 3 the program viewer can be notified of this, and the program viewer can be prompted to select and watch some promotional content. The promotional content selections can be displayed by the application ABC to the user for selection, and once selected the promotional content can be displayed by the device 20. The objective in allowing the user to select and watch the promotional content is to provide them with another opportunity to enter a valid response and it provide the content distributor with another opportunity to present promotional content to the user. If at this point the user enters a valid response to a question posed by the application ABC, the process can proceed to Step 4.

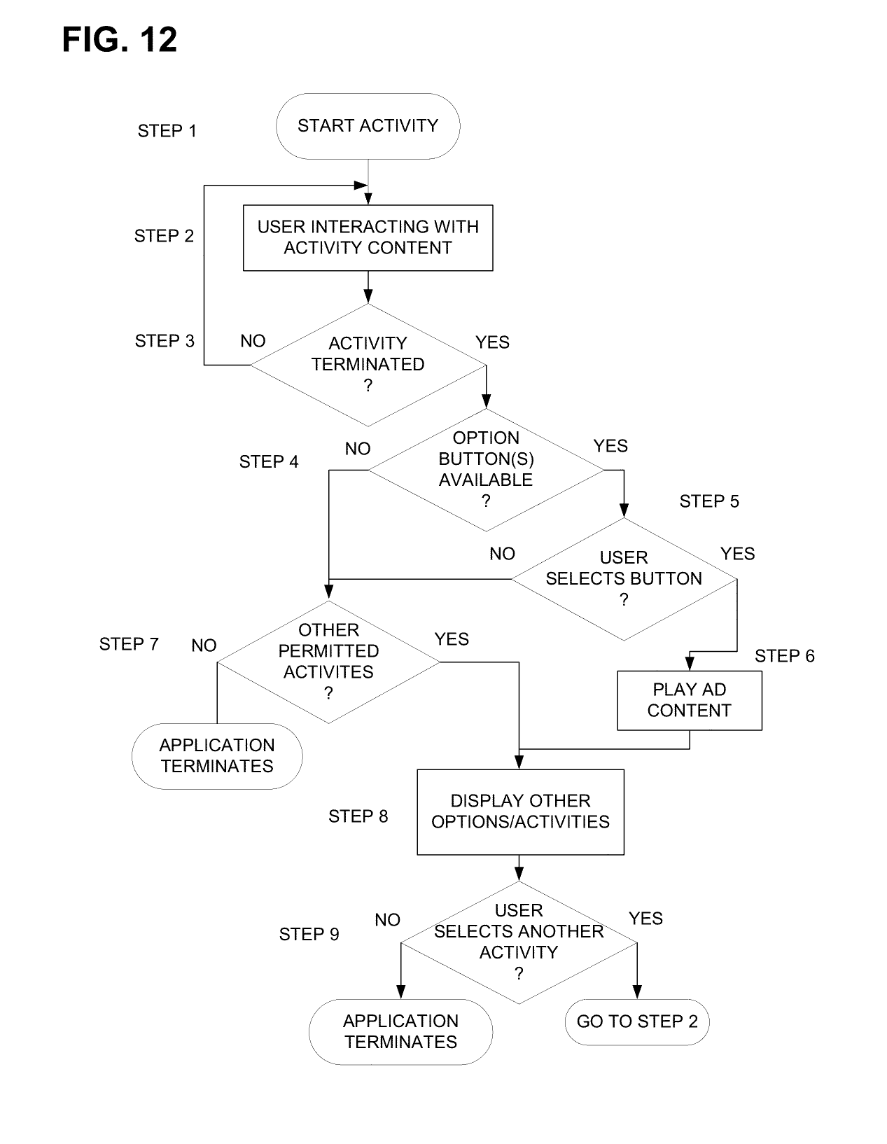

As previously described with reference to FIG. 7, optional functionality (in the form of option buttons) can be associated with each activity that a user is permitted to participate in. These option buttons are pointers to promotional content and optional activities that the user can select during the time they are participating in the current selected activity, or after the current activity has ended. In this regard, a user can select any of the buttons 72, 73, or 74 described with reference to FIG. 7, to control the application ABC to play the promotional content, and/or to be permitted to continue to participate in the current activity, another iteration of the current activity or to participate in another activity that they are or are not otherwise permitted to participate in. The operation of the application ABC after a user has selected any one of the activities (A-Z) to participate in will now be described with reference to FIG. 12.

In Step 1 of the process illustrated in FIG. 12, and subsequent to the user in FIGS. 11A and 11B selecting an activity that they are permitted to participate in, the selected activity is displayed in a screen by the device 20, and in Step 2 the user starts to interact with the activity content. In Step 3, if the content associated with the activity is still playing, then the process returns to Step 2 and loops between Steps 2 and 3 for as long as the content associated with the activity is playing on the device 20. At the point in time that the activity terminates, the process proceeds to Step 4 where the user can determines whether or not there are any option buttons available to select. If in Step 4 there are no option buttons displayed in the screen (sixth screen described with reference to FIG. 7) associated with the activity content, the process proceeds to Step 7, otherwise the process proceeds to Step 5 and the user can select a button or not. If the user does not select a button, the process proceeds to Step 7. On the other hand, if the user selects an option button the process procedes to Step 6 and the application ABC plays the promotional content on the user device, and the process proceeds to Step 8. In Step 8, the activity screen (fifth screen described in FIG. 6) can display one or more activities (i.e., another play or other different activity options) for selection, and in Step 9 the user can select any one of the activities displayed in Step 8. Returning to Step 7, the logic 81 determines whether the user is permitted to participate in any other activities, and if so the process proceeds to Step 8, otherwise the application terminates.

While the logical process described with reference to FIG. 12 assumes that the activity terminates prior to a user being able to select an option button, this does not necessarily have to be the case. In another embodiment, the user can be permitted to select an option button at any time subsequent to the start of their interaction with an activity.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

We claim:

1. A method of incenting an individual to view an instance of promotional content, comprising:
displaying a listing having at least one instance of promotional content from which the individual who is a user of an interactive computer application can select;
selecting and viewing by the user the least one instance of the promotional content;
displaying at least one question that the user can select that relates to the at least one selected instance of promotional content;
the user selecting at least one question and entering a response to the selected question into the interactive application; and
rewarding the user for watching the selected instance of promotional content provided the interactive application determines that the response to the selected question is correct.

2. The method of claim 1, wherein the user is permitted to receive a reward of variable value depending upon the number of correct responses that are received by the interactive computer application.

3. The method of claim 1, wherein the interactive computer application is accessible to the user over a network.

4. The method of claim 1, wherein the interactive computer application is available to the user after completing a registration process.

5. The method of claim 4, wherein the registration process is initiated by the interactive computer application which operates to gather metric information from the user.

6. The method of claim 5, wherein the metric information gathered by the interactive computer application comprises user demographic information and user activity statistic information.

7. The method of claim 1, further comprising the interactive computer application displaying at least one instruction that allow the user to find and view the instance of promotional content.

8. The method of claim 5, wherein the content of the at least on question displayed for selection by the user is influenced by the demographic group of which the user is a member.

9. The method of claim 5, wherein the user metric information determines which of the at least one instances of promotional content is displayed to the user for selection.

10. The method of claim 5, wherein the user metrics influence the creation of each instance of the promotional content.

11. The method of claim 10, wherein each instance of the promotional content is tailored for viewing by a particular demographic group comprising an audience.

12. The method of claim 1, wherein the reward is a permission for the user to participate in one or more of an activity.

13. The method of claim 12, further comprising the interactive computer application displaying a list of the one or more activities that the user is permitted to participate in.

14. The method of claim 13, further comprising the user selecting an activity form the list of permitted activities, and interacting with content associated with the activity.

15. The method of claim 14, wherein the content associated with the activity that the user is permitted to participate in comprises any one or both of a textual or multimedia content.

16. The method of claim 14, wherein the content associated with the activity that the user is permitted to participate in comprises optional instructions that the user can select to control the activity they are currently participating in.

17. The method of claim 16, wherein the optional instructions are selectable by the user before, during, or after that time that the user interacts with the content associated with the selected activity.

18. A system for incenting an individual to view an instance of promotional content, comprising:
a display device for playing a promotional content selected by an individual using an interactive computer application; and
a mobile communication device running the interactive computer application which operates to display one or more questions to the user that relate to the selected promotional content they are viewing, the user responding to at least one of the questions; and
the interactive computer application operating to reward the user for watching the selected instance of promotional content provided the that the response to the selected question is correct.
